(19) United States
(12) Patent Application Publication
(10) Pub. No.: US 2015/0143211 A1
(43) Pub. Date: May 21, 2015

(54) LINK INSERTION AND LINK PREVIEW FEATURES

(71) Applicant: Microsoft Corporation, Redmond, WA (US)

(72) Inventors: Jonathan Kaufthal, Seattle, WA (US); Daniel Fairweather, Socorro, NM (US)

(73) Assignee: Microsoft Corporation, Redmond, WA (US)

(21) Appl. No.: 14/082,479

(22) Filed: Nov. 18, 2013

(51) Int. Cl. G06F 17/22

(52) U.S. Cl. CPC G06F 17/2235
USPC 715/205

(57) ABSTRACT

Embodiments encompass linking features that enable creation, insertion, and/or modification of links and/or link previews, but the embodiments are not so limited. A computer-implemented method of an embodiment operates to provide a link tool interface that can be used to generate link previews that may be inserted as part of a link source. The link tool interface of an embodiment is configured to store a link preview for use and reuse. A device of an embodiment is configured with a link tool interface configured to display an insert link dialog that enables users to manage links, including creating, modifying, and/or inserting link previews. Other embodiments are included.

### BACKGROUND

Currently, a number of end-user applications enable users to create links (sometimes referred to as “hyperlinks”) that can be inserted and used to link to a link target, such as a file or web page for example. Allowing users to insert links can enhance the end-user experience by providing a mechanism to easily and quickly access external information referenced by a link. Users wishing to insert links in a particular application may be presented with a user interface for creating the links in that application. A user can type the address or other identifier for a resource the user wishes to link to via the link. Alternatively, the user may use a web browser to determine the text for the link, and then copy and paste the text into the user interface for creating the link.

Although links sometimes are inserted into word processing documents, mail items, or other text-based files, the linked information may be associated with other applications such as a web browser. One issue stems from the fact that users may have to switch between various applications in order to insert a single link which can lead to confusion as to the initial goal. Moreover, with the enormous growth of touch-based devices/systems, current link dialogs are unable to efficiently gather pertinent information from the user's context as part of providing a touch friendly user interface that allows for the insertion and/or management of links. Users may also prefer a link tool that may be launched independently of a particular application and allow a user to insert a link that conveys more than merely a link address or display text.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments encompass linking features that enable creation, insertion, and/or modification of links and/or link previews, but the embodiments are not so limited. A computer-implemented method of an embodiment operates to provide a link tool interface that can be used to generate link previews that may be inserted as part of a link source. The link tool interface of an embodiment is configured to store a link preview for use and reuse. A device of an embodiment is configured with a link tool interface configured to display an insert link dialog that enables users to manage links, including creating, modifying, and/or inserting link previews. Other embodiments are included.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of an exemplary computing architecture according to an embodiment.

FIG. 2 is a flow diagram depicting an exemplary process of using a link tool interface according to an embodiment.

FIGS. 3A-3E depict exemplary link insertion and preview features enabled in part by a link tool interface.

FIGS. 4A-4B depict link preview examples.

FIG. 5 is a block diagram illustrating an exemplary computing environment for implementation of various embodiments.

FIGS. 6A-6B illustrate a mobile computing device with which embodiments may be practiced.

FIG. 7 illustrates one embodiment of a system architecture for implementation of various embodiments.

### DETAILED DESCRIPTION

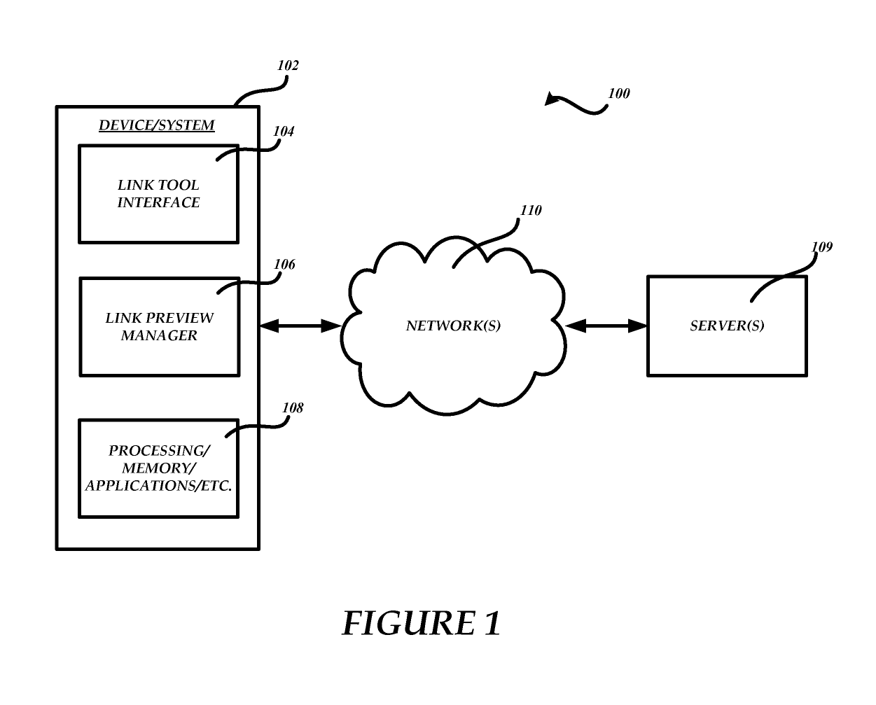

FIG. 1 is a block diagram of an exemplary computing architecture 100 according to an embodiment. As described below, components of the exemplary architecture 100 operate in part to provide linking features including the ability to insert, modify, and/or view one or more link previews associated with one or more link targets, but is not so limited. As shown in FIG. 1, the exemplary architecture 100 includes a device/system 102, a link tool interface 104, a link preview manager 106, and processing/memory/applications/operating system(s)/other resources/etc. (collectively shown as 108). It will be appreciated that complex communication architectures typically employ multiple hardware and/or software components including, but not limited to, server computers, networking components, and other components that enable communication and interaction by way of wired and/or wireless networks.

The device/system 102 is coupled to one or more server(s) 109 via one or more networks 110. Depending in part on the application context and/or state, device/system 102 may or may not be actively coupled to server(s) 109 and/or other user devices/systems. An exemplary device/system 102 is representative of a handheld or portable computing device, such as a tablet, smartphone, etc., as well as desktop, laptop, gaming, server, and other computing devices/systems. As described below, the device/system 102 can use the link tool interface 104 and/or link preview manager 106 to provide link preview inserting and persisting operations. For example, the link preview manager 106 can operate to generate link previews associated with relevant link targets which can be used by the link tool interface 104 as part of displaying link preview suggestions as potential insertions in some link source or host.

As used herein, link target of an embodiment refers to an electronic item or portion thereof addressed by or pointing to from a link and link source of an embodiment refers to the place or location of insertion within a source item. As described below, a link preview of an embodiment includes a title portion, an address portion, a description portion, and/or a thumbnail portion. As examples, link previews can be generated for link targets such as a contacts, calendar items, email senders/recipients, word processing documents, spreadsheets, presentation slides, web pages, etc. Those skilled in the art recognize that current operating systems include an ability to provide different types of file views. For example, the MICROSOFT WINDOWS operating systems support a “tiles” view that enables display of user files as tiles that include an icon, a file name, type of file, and file size. It will be appreciated that similar methods can be used to generate link previews albeit with differing content.

Each link preview is configured for user interaction, whether for modification purposes or navigation operations. According to each interaction paradigm, all or some portion(s) of a link preview can be interacted with (e.g., tapped, clicked, etc.) to navigate to an associated target. The link tool interface 104 can be configured to allow a user to modify a link preview, such as by using a different thumbnail image or icon or changing the description for example. Since the link previews can be persisted or displayed with a link source, users are able to obtain a comprehensive understanding of where a link will take them. Link previews can be stored separately at local and/or remote location and/or inserted at the time of rendering or integrally stored as part of the link source. In one embodiment, the functionalities of the link tool interface 104 and link preview manager 106 can be combined and implemented as a single component to generate, insert, modify, persist, and/or otherwise provide/manage link previews.

As will be appreciated, links (sometimes referred to as hyperlinks) can be configured to point to certain link targets and, when activated, navigate to the corresponding link targets. The link tool interface 104 can also be used for deep linking operations, described further below. As an example, a link target may be representative of electronic information or items such as a host, domain, an email mailbox, a word processing document or some part or portion, a web page or some part or portion, an electronic spreadsheet or some part or portion, an electronic presentation slide or some part or portion, an electronic note or some part or portion, etc.

As further example, a link source may be representative of electronic information or items, such as an email body, a word processing document, a web page, an electronic spreadsheet, an electronic presentation slide, an electronic note, etc. in which a link is or is to be inserted. For example, the link tool interface 104 allows a user to choose inserting a rich link preview directly into an email message or word processing document for example. Thus, a link and/or link preview can be inserted into a link source and, when activated, navigate to a link target defined by the link address.

The link tool interface 104 and link preview manager 106 of an embodiment are each configured with complex programming code that, when executed, operates to provide link management and/or preview features, but is not so limited. The link preview manager 106 of an embodiment is configured to generate and/or manage link previews based in part on an application type associated with a link target. For example, the link preview manager 106 can populate title, address, description, and/or thumbnail portions of a link preview using an object model, such as document object model for example. The link preview manager 106, with or without a dedicated service, can operate to generate and/or manage link previews for use by the link tool interface 104 in part by identifying relevant portions of a link target to use in populating the various parts of a corresponding link preview. For example, the link preview manager 106 can first refer to local memory for applicable link preview information before making a call to server(s) 109.

As an example, depending on the link target, the link preview manager 106 can use an identification and population algorithm to generate a rich link preview. For example, if a user selects a table of a spreadsheet as a link target, the link preview manager 106 can operate to use a file name or sheet name as a link preview title, a local or remote path to the table as a link preview address, a link preview description, and an image of the linked table as a link preview thumbnail. As another example, if a user selects an electronic note as a link target, the link preview manager 106 can operate to use a file name or note name as a link preview title, a local or remote path to the note as a link preview address, the first few lines as a link preview description, and an image of the note or the first image contained therein as a link preview thumbnail

The link tool interface 104 can be configured to employ touch targets for users that are adequate in size and further to minimize amounts of user input (e.g., slow, awkward soft keying), while using each user's context to provide likely or relevant link targets (e.g., recent web browsing, recent office productivity documents, clipboard items, recent emails, etc.), so that the user can insert a link and/or link preview with just a few taps. The link tool interface 104 is also configured to use an address or other input portion as a search interface for searching within context to quickly identify relevant link previews. The link tool interface 104 enables users to deep link into some identified portion of an electronic file, such as by directly linking to a specific section of any document including a currently opened document (e.g., “history of Australia” section of a word processing document, an “appendix” slide of a presentation file, a table of a sheet of a spreadsheet application, etc.). Depending on implementation, features of the link tool interface 104 and/or link preview manager 106 may be included with one or more distinct applications or some other component(s), such as an O/S or browser component for example.

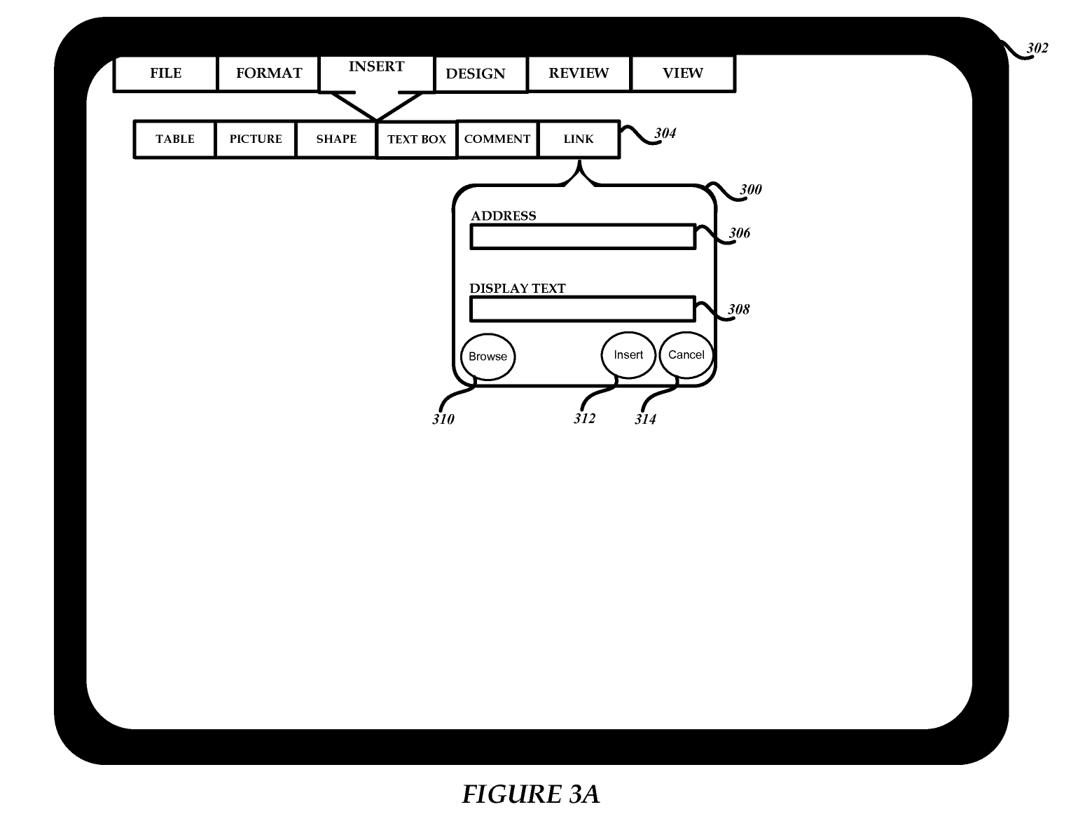

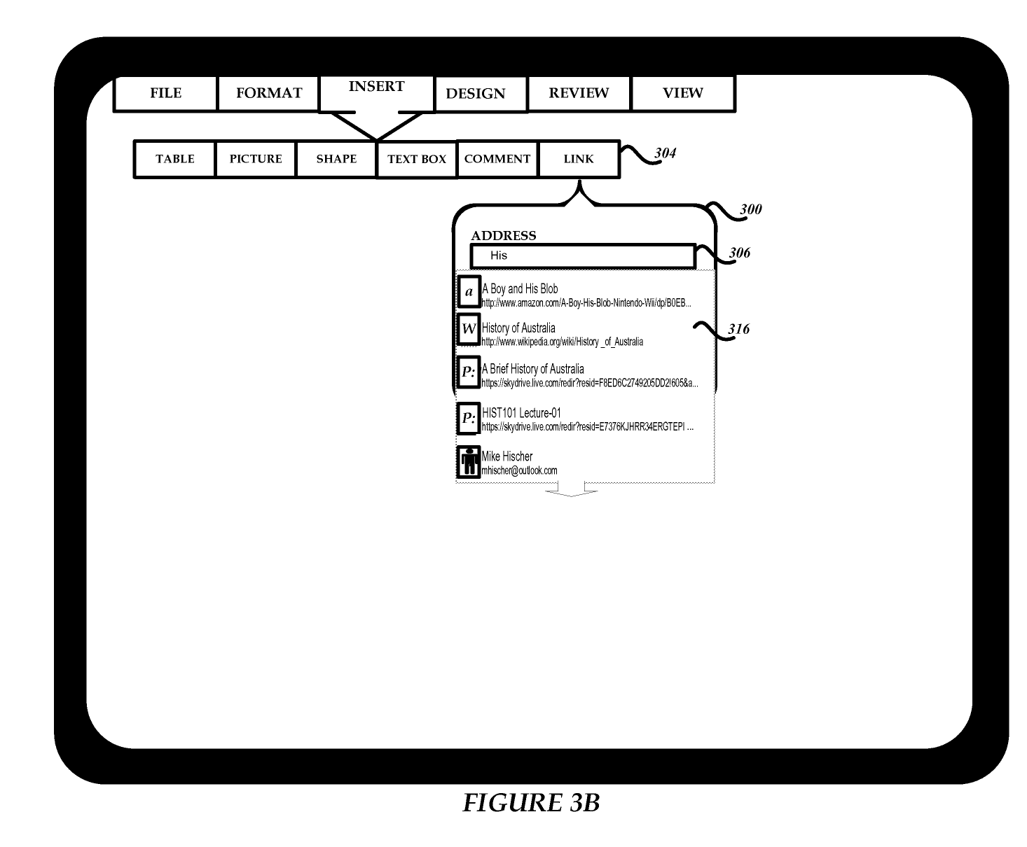

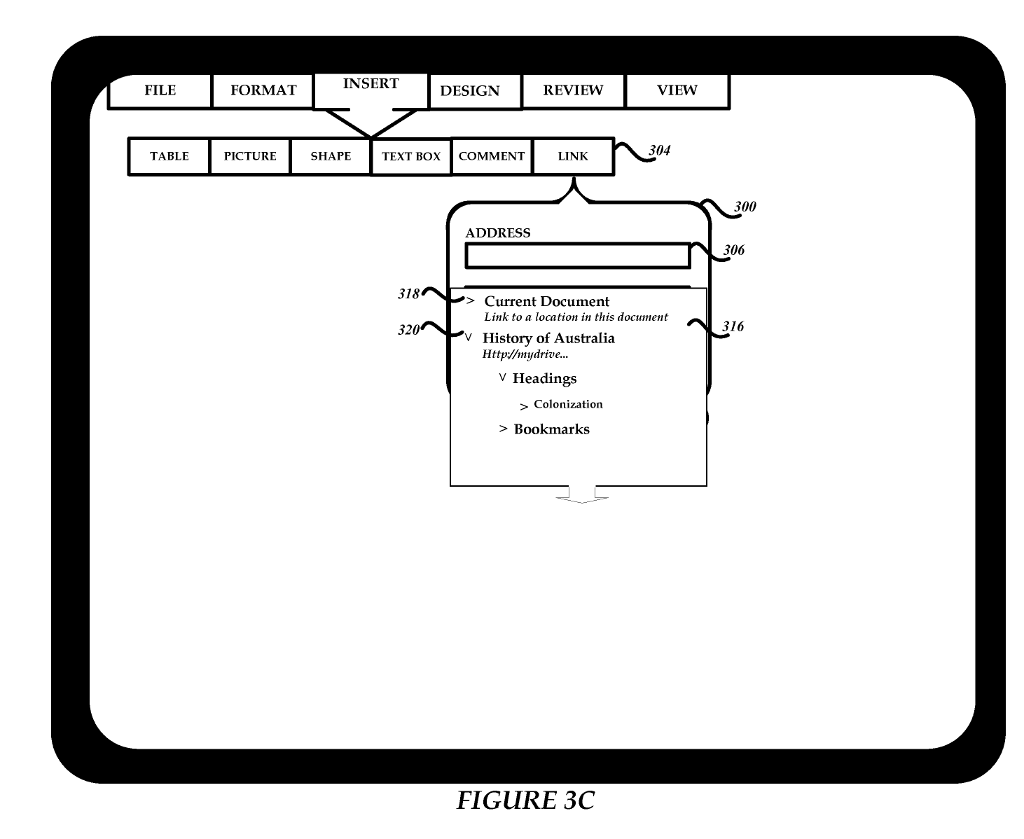

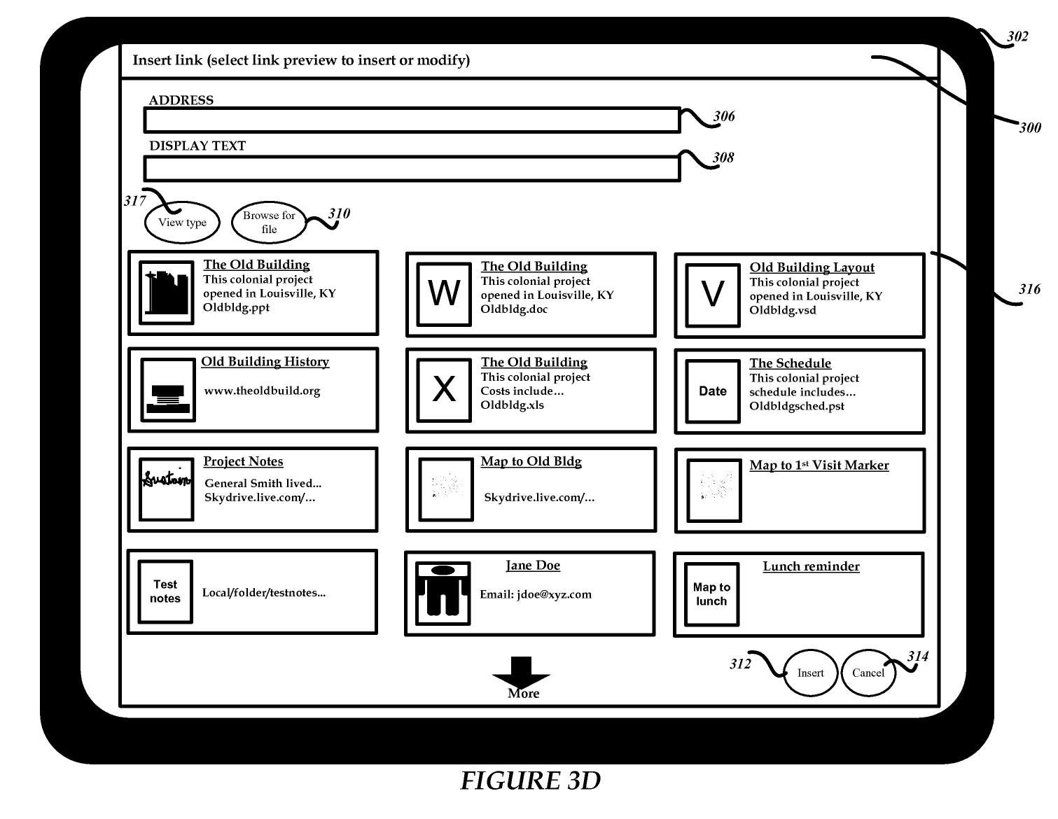

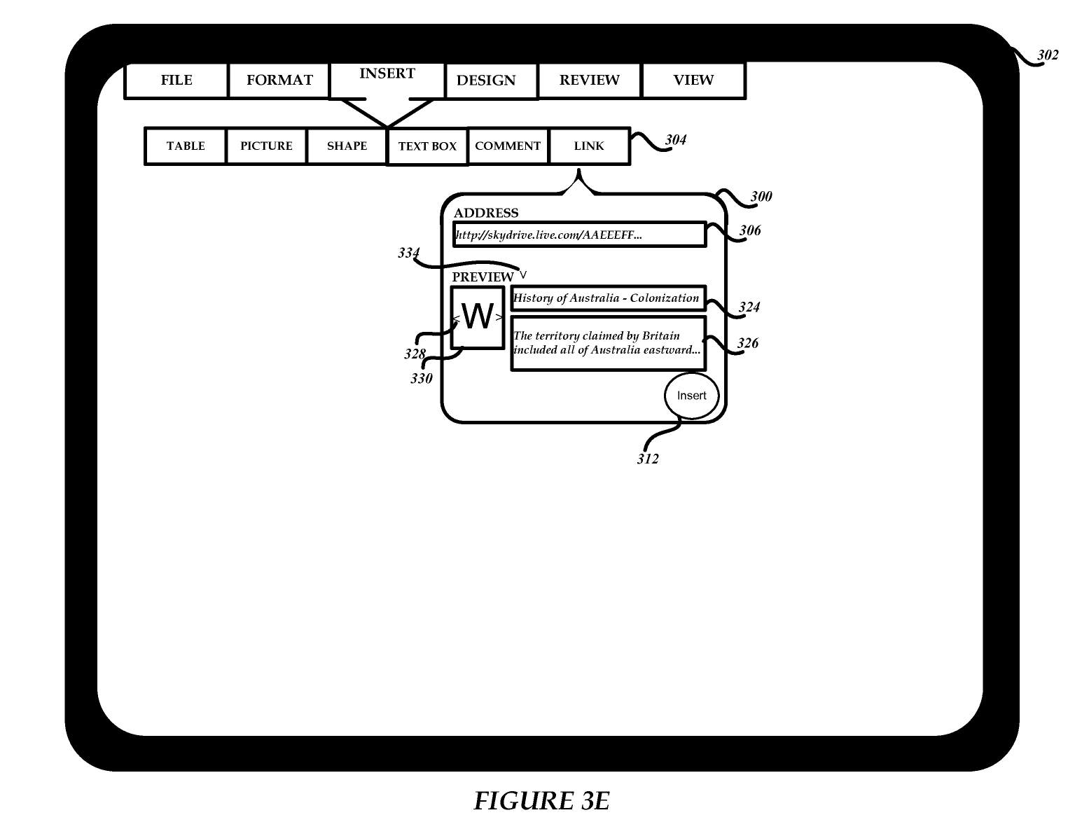

As described below, the device/system 102 can use the link tool interface 104 to display an insert link dialog or callout (see FIGS. 3A-3E) that affords users control over links and/or link previews. An insert link callout of one embodiment is an interactive object configured to receive touch and other user inputs (e.g., mouse, voice, etc.) in part to provide one or more relevant or potentially relevant link previews using information pulled from various sources. The insert link callout of one embodiment is configured to display a number of items relevant to the user. For example, the insert link callout can be configured to display a number of most recently used (MRU) items based in part on the user and/or application context as link previews. Relevant items can be displayed according to what the user may be interested in linking, such as favorite web pages, contacts from an address book, predictions based on the content of your document and/or what others are linking to, etc.

MRU item examples include recently visited web pages, recently used office productivity files (e.g., word processing documents, spreadsheets, presentation slides, notes, etc.), recent notes, recent email correspondence, and/or other linkable targets. In one embodiment, server(s) 109 operates in part to support creating and/or persisting link previews and/or provide access, synchronization, and/or saving features for user applications (e.g., SKYDRIVE service). For example, the link preview manager 106 can operate to make a call to server(s) 109 to update link preview information as part of populating and/or updating link previews. It will be appreciated that link previews may be pre-generated or generated as needed when inserting and/or viewing.

As will be understood, a link can be used to navigate to a link target and describes a mapping to the link targets. Objects including text, images, videos, maps, shapes, etc. can be linked to external or internal resources identified by a link address such as a uniform resource locator (URL), remote or local file path, email address, etc. When an object becomes linked, it retains all of its original features while inheriting link features. For example, a linked image is both a link and an image, and therefore, contains image operations such as resize and format in addition to link operations such as open and remove. A link address of an embodiment can be described as including between one and four parts. Together, the parts of the link address define how to transfer data, where the data is located, and attributes for manipulating the transferred data. For example, an address can be configured as one or more of [Protocol] and/or [Path] and/or [Anchor] and/or [Attributes].

The protocol can be configured to define how an address is to be transferred and/or opened. For example, familiar protocols include http://, file:///, mailto:, and the like. An operating system uses various protocols and/or maintains a mapping between protocols and applications. It will be appreciated that a protocol may be optional since the protocol may be deduced from the path. The path can be configured to specify the location of data. For example, the path en.wikipedia.org/wiki/URL specifies the location of a webpage on Wikipedia under the wiki/URL directory. Likewise, an email such as user@email.com defines a path to an electronic mailbox located at email.com.

The anchor of one embodiment can be configured to specify a location within a file. This allows for users to link to a specific section within a document or webpage. Attributes can be configured to enable specification of additional parameters for an address. For example, linking to a website with the attribute bgColor=′blue′ might open the page with a blue background rather than the default background color. The link tool interface 104 can be configured to add desired attributes. Links may be configured as object add-ons taking on many different forms. According to an embodiment, the link tool interface 104 provides a means of inserting links as display text or a raw address, a link preview comprising an object which contains one or more of a title, address, description and/or thumbnail. If a link is attached to an object such as text or an image, the link can be formatted as that object. Additional link features are described further below.

While some embodiments have been described, various embodiments may be used with a number of computer configurations, including hand-held devices, multiprocessor systems, microprocessor-based or programmable consumer electronics, minicomputers, mainframe computers, etc. Various embodiments may be implemented in distributed computing environments using remote processing devices/systems that communicate over a one or more communications networks. In a distributed computing environment, program modules or code may be located in both local and remote memory. Various embodiments may be implemented as a process or method, a system, a device, article of manufacture, etc.

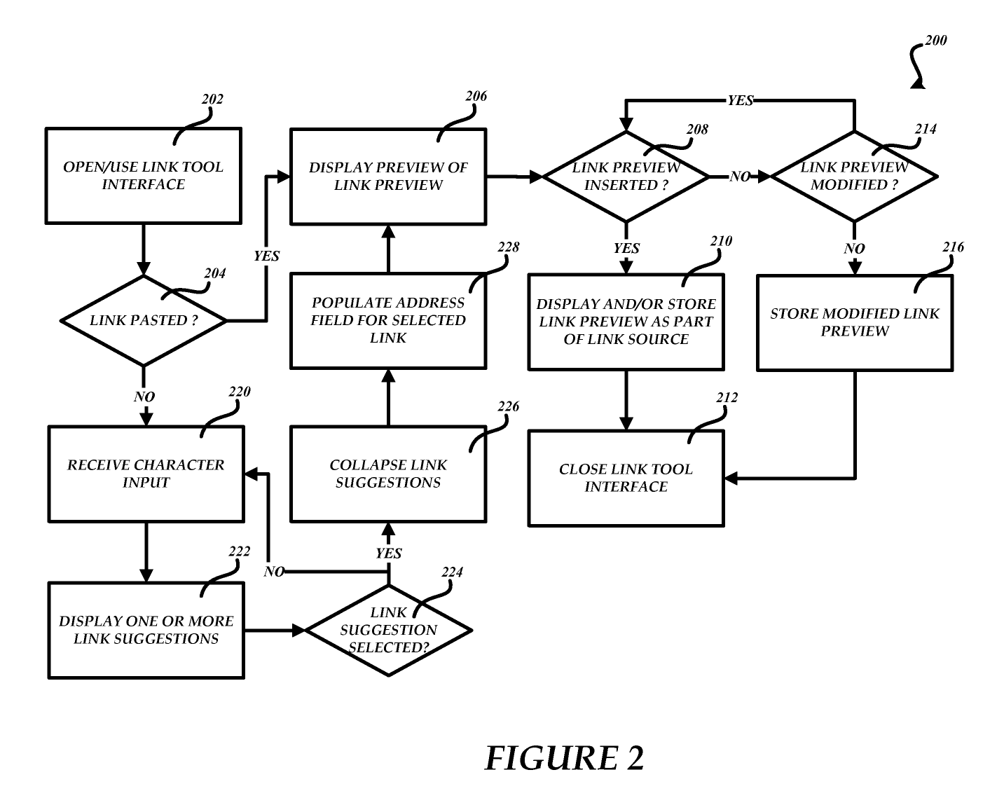

FIG. 2 is a flow diagram depicting an exemplary process 200 of using a link tool interface according to an embodiment. The process 200 at 202 begins when a user opens or uses the link tool interface as part of inserting a link or link preview into a link source. For example, the process 200 at 202 can operate to display a link tool interface after receiving user input to an insert link ribbon item. At 204, the process 200 of an embodiment determines if a link has been pasted into a link address field of the link tool interface. If a link has been pasted into the address field of the link tool interface at 204, the process 200 at 206 operates to display a preview of a link preview that may be inserted into the link source.

If the link preview is inserted at 208, the process 200 at 210 operates to display and/or store the link preview as part of the link source. For example, the process 200 at 210 can operate to display the link preview at an insertion location in the link source while storing the population information for the link preview object in local and/or remote storage separately and/or as part of the link source. In one embodiment, the process 200 operates to store link previews absent an insertion step. At 212, the process 200 operates to close the link tool interface.

If the link preview is not inserted at 208, the process 200 at 214 determines if the link preview has been modified, such as a result of editing of a thumbnail portion, title portion, or description portion of the link preview for example. If a modified link preview is inserted at 208, the process 200 continues to 210-212 as described above. If a modified link preview is not inserted at 208, the process 200 at 216 operates to store the modified link preview before closing the link tool interface at 212. For example, a modified link preview object can be stored in local or remote storage for subsequent use when inserting a link with a link source.

Returning to 204, if a link was not pasted at 204, the process 200 operates at 220 to receive character input into an address or search field. At 222, the process 200 operates to display one or more link suggestions based on the input. In one embodiment, the process 200 operates to pre-generate link suggestions and/or link previews based in part on a user or application context. As the user types or otherwise enters characters, the process 200 at 222 can be configured to refine link suggestion results by updating the display of link suggestions. Depending on the configuration or implementation preference, the link suggestions may be displayed as text, a URL, a limited link preview, a rich link preview, or in some other manner. The process 200 at 222 of one embodiment can operate to display one or more suggested links absent requiring a user to enter one or more characters.

If a link suggestion is not selected at 224, the process 200 returns to 220. If a link suggestion is selected at 224, the process 200 at 226 operates to collapse the link suggestions. At 228, the process 200 operates to populate the address field for the selected link before proceeding to 206 to display a preview of the link preview and so forth as described above. The process 200 at 206 of an embodiment can operate to display a link preview by gathering pertinent information from an associated link target. For example, a link preview generator or manager can operate in part to populate a preview of a link preview for a word processing document to include a document title as a link preview title, a local or remote path as a link preview address, a first number of lines or characters as a link preview description, and an image or logo as a link preview thumbnail.

As another example, a preview of a link preview associated with an email address can be displayed to include a recipient name as a title, the email address as the link preview address, a description, and an image of a contact as a link preview thumbnail. It will be appreciated that previews of link previews and link previews can be populated in a variety of ways depending on the link target/source and/or application context and the examples and embodiments described herein are not intended to be limiting. While a certain number and order of operations are described for the exemplary flow of FIG. 2, it will be appreciated that other numbers and/or orders can be used according to desired implementations.

FIGS. 3A-3E depict exemplary link insertion and preview features enabled in part by a link tool interface 300 executing using a user device/system 302. An exemplary link tool interface 300 can be configured as a callout type interface (FIGS. 3A-3C and 3E). The link tool interface 300 can also be configured to provide a more immersive experience (FIG. 3D). The link tool interface 300 of one embodiment can be configured with a control that allows a user to switch between a callout interface or a more immersive interface. It will be appreciated that complex programming code can be used to provide aspects of a multi-faceted link tool interface 300 when executed by processing components of an associated device/system. As shown in FIG. 3A, the link tool interface 300 has been displayed with a display or screen in response to a user activating a ribbon link control 304, such as by tapping the ribbon link control 304 for example. The exemplary link tool interface 300 includes a link address input portion 306, a display text input portion 308, a browse control 310, an insert link control 312, and a cancel control 314. The link tool interface 300 can also be dismissed by tapping outside of the callout.

The browse control 310 of one embodiment is configured to launch an operating system file locator pre-set with one or more of local and/or remote drive locations, such as one or more MRU locations for example. In one implementation, a folder icon can be displayed within the control to indicate its use to launch a file browser. The browse control 310 includes functionality to respond to the user context, such as during a current session. For example, the first time the user inserts a link in a session, a dedicated file repository can be used, and if the user then changes the file browser control to access local files, the link tool interface 300 can track the change and launch the local file picker on subsequent browse button taps.

The insert link control 312 of one embodiment operates in response to user interaction to insert a specified link preview at the current insertion point and dismiss the callout. In one embodiment, link previews are inserted by ensuring similar display characteristics as other objects, text, etc. existing in the link source. Once inserted, a link preview can be anchored such that resizing and viewing do not interrupt the user experience. This insert link control 312 can be disabled if any required fields are empty, such as title, description, and/or thumbnail for example, if the preview format is selected. If all required fields are filled, the insert link control 312 can be enabled, allowing the user to insert the link preview at the insertion point.

The link tool interface 300 of an embodiment can be invoked in different ways, such as from a ribbon menu, context menu, and/or in some other manner. As an example, the link tool interface 300 may be invoked from a ribbon menu by tapping the ribbon link control 304 of a parent “Insert” ribbon control causing the link tool interface 300 to be anchored or located relative to the ribbon link control 304. As further example, the link tool interface 300 may also be invoked from a context menu. In such a case, the link tool interface 300 can be anchored to the insertion point or selection. The link tool interface 300 can be anchored above, below, or beside the anchor, depending in part on display or screen area constraints. Should the link tool interface 300 be invoked while text or some other object is selected, the display field and/or link preview portions can be automatically populated with link preview information. Tapping or clicking outside of link tool interface 300 boundaries can be configured to cause the interface to dismiss. In case of accidental dismissal, the contents of each link preview portion can be saved and repopulated.

FIG. 3B shows the link tool interface 300 displaying a number of link suggestion in a search results area 316 for potentially relevant link targets. One or more link suggestions can be presented with or without requiring the receiving of user input in the link address input portion 306. For example, one or more link suggestions can be displayed upon opening the link tool interface or tapping in the link address input portion 306. The link address input portion 306 is configured to operate as a search interface allowing a user to tap or click within the input area and enter one or more search characters or terms. The search results area 316 of one embodiment is populated with a list of MRU items which have been recently opened or used with a suite of office productivity or other applications. Thus, the link address input portion 306 doubles as a search interface to filter results, such as the MRU items for example, as well as providing a user with an ability to deep link to link targets. In one embodiment, each link suggestion includes four major components including a title, an address such as a URL or file path associated with the item, an icon or image representing a file or application type, and/or a glyph control that operates to expand or collapse the deep link targets.

As one illustrative example, typing or tapping to search operates to display a list of link suggestions associated with office productivity documents, web pages, people, email addresses, etc. For this example, a description of each link suggestion is not displayed due to configuration settings and/or display constraints. As shown for this example, each link suggestion provides information associated with a potentially relevant link preview, such as a distinct thumbnail, title, and link address that enables at a glance identification and selection of a link suggestion as part of inserting an associated link preview. For this example, the search results area 316 includes MRU items of diverse item types relevant to the search input, user, and/or context of the link insertion operation. In one embodiment, additional information can be displayed with each link suggestion to further quantify an associated link preview that may be of interest for insertion.

FIG. 3C depicts an embodiment of the link tool interface 300 that is configured to prioritize or anchor display of a current item (word processing document for this example) while integrating deep links inline below search results. In one embodiment, rather than displaying an address, the phrase “Link to a location in the current item” can be shown for deep linking interaction. As shown, the search results area 316 includes an expand glyph 318 to inform the user of an ability to expand the current document or another document or file into sub-sections or sub-portions, a collapse glyph 320 to inform the user that a search item is expanded and can be collapsed back into the associated search result. Potential link targets can include the search results as well as the sub-portions of any expandable search result.

Deep links can include links to anchors and targets. In one implementation, the search results area 316 supports deep linking using a tree-like structure. Tapping an expand glyph can operate to expand the tree structure to reveal locations within the item that can be linked to. The expand/collapse glyph can also be assigned to an internal location. For example, a heading may be expanded to reveal subheadings. It will be appreciated that each application and/or file may include different types of internal locations or portions which may be linked to such as document headings and bookmarks, presentation slides and notes, spreadsheet sheets and tables, drawing objects, note sections and pages, etc.

FIG. 3D depicts the link tool interface 300 configured with more immersive features according to one embodiment. For this example, the link tool interface 300 is configured as a fully-immersive (e.g., substantially covers an underlying link source) or near-immersive (e.g., covers very wide pane that covers about 80-90% of the link source) insert link control. As described above, the link tool interface 300 can be displayed after selection of the ribbon link control 304 or as a result of some other user input.

As shown in FIG. 3D, the link tool interface 300 of an embodiment is configured to display a plurality of potentially relevant link suggestions in the search results area 316. View type control 317 can be used to filter and/or display link suggestions according to some view type, such as link previews associated with a time, timeframe, and/or context, document based link previews, web page based link previews, people based link previews, etc. For this example, each link suggestion includes a thumbnail, a title, a link address, a descriptive snippet, and/or a temporal value. It will be appreciated that the display of the link preview suggestions can include additional or less information.

According to an embodiment, the address field may be a required field which specifies the URL, file path, or email to open when the link or some defined portion of a link preview is actuated. To make entering addresses easier, a soft keyboard can be used. As described above, the link address field can also be used as a search box, and therefore, can be given focus when the link tool interface 300 is first opened. As described above, tapping or clicking in the search box or area can invoke display of a plurality of link suggestions in the form of link text or as rich link previews as suggested link targets that a user may desire, such as MRU items for example, in the search results area 316 as part of a more immersive linking interface. The display text field can be displayed optionally to specify the link text to be displayed with an inserted link preview.

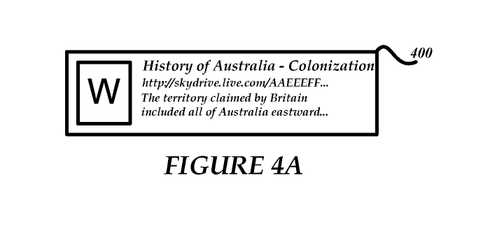

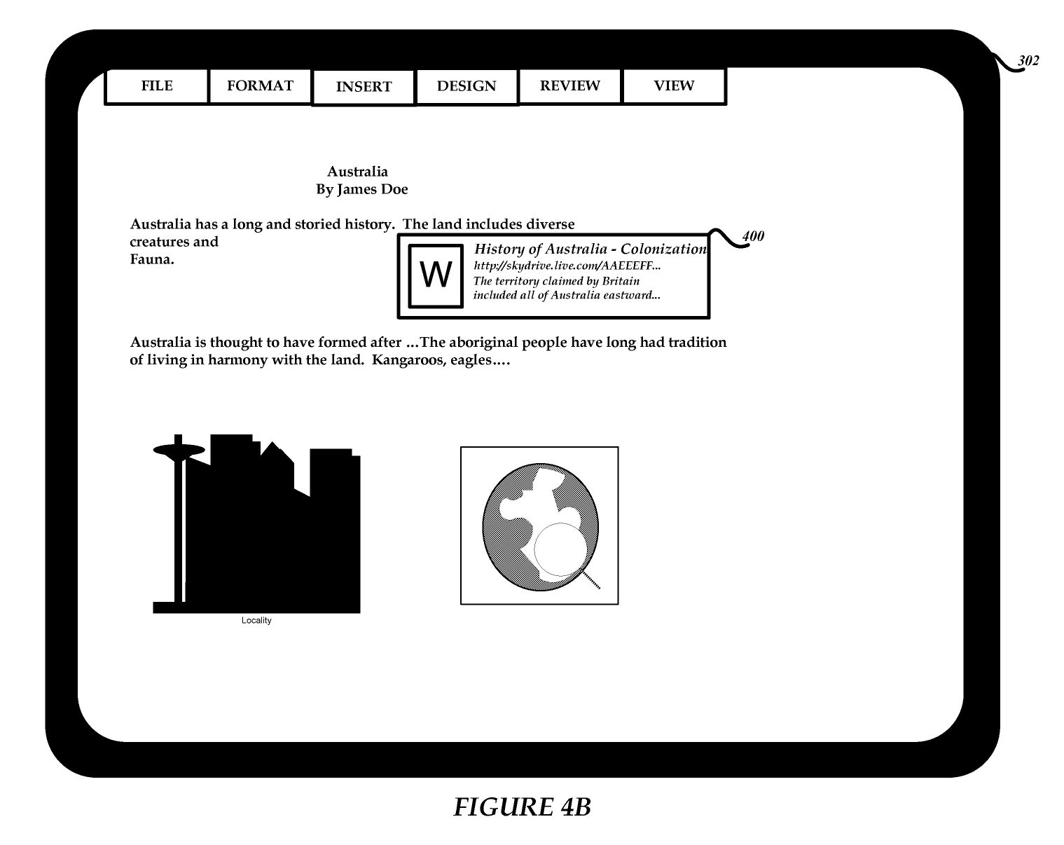

According to an embodiment, if the link tool interface 300 is invoked while text is selected, the display text field can be populated with the selected text. The display text field can be disabled if linking an image or shape. A user can tap or click one of the displayed link suggestions to display a preview of a link preview that may be inserted into the link source as shown in FIG. 4B. Depending on the implementation configuration, tapping or clicking a displayed link preview can result in automatic insertion of a suggested link absent display of a separate preview for an associated link preview (as shown in FIG. 3E for example) before insertion into a link source.

FIG. 3E depicts the link tool interface 300 after a user has selected (e.g., tapped or clicked) one of the link suggestions as a potential candidate for inserting into a link source. As shown by this example, the link tool interface 300 has transformed to enable modification of a link preview that users will see when viewing the link source after insertion or as part of a link suggestion. The more immersive implementation described above can also be configured to display a modifiable link preview after selecting a displayed link preview with or without a callout type display configuration. According to this example, a user who has opened the source and is viewing the link preview would see a word processing application icon as a thumbnail for the link target, a title of the link target in a title area 324, and a brief description of the link target in a description area 326. In this state of the link tool interface 300, a user is able to view and/or modify one or more portions of the link preview before inserting.

Selectors 328 enable the user to switch between different items (e.g., icons, images, videos, etc.) to display in the thumbnail display area 330. While the link preview can be pre-populated with different types of information, the link tool interface 300 enables the user to customize each link preview. The insert link control 312 can be used to insert the link preview into the link source. As shown for this example, the browse control 310 and cancel control 314 have been hidden at this point in the process. The link format selector control 334 of an embodiment is configured to allow a user to specify which link format to use when inserting. As shown, the different portions of the modifiable link preview can be used to create a custom link preview for insertion. The link format selector control 334 can be used to switch between the rich link preview shown or a display text view, but is not so limited.

FIGS. 4A-4B depict link preview examples. FIG. 4A depicts an exemplary link preview 400 (not to scale) resulting from use of the insert control 312. FIG. 4B depicts an example link preview displayed at a link insertion point in a link source. As shown, each of the title, link address, description, and thumbnail link preview portions have been integrally formed into the final link preview presentation. As described above, the link preview can be persisted with the link source, such that users of the link source are able to view the rich link preview. Correspondingly, if the link preview was configured and inserted to only display the display text, then users of the link source would be able to view the display text.

In one exemplary implementation, link previews are inserted to be readable without unnecessarily obscuring aspects of the link source. Once inserted, link previews are intended to flow and mesh with content of the link source. The link preview control can be configured to enable a user select to not include or not display a thumbnail as well as an option of switching between different thumbnails while viewing a snapshot of information associated with a link target provided by a link preview. Link previews can be generated automatically to populate the various link preview display portions or fields. For example, the link tool interface can operate to generate a link preview for a video at a video site by including an embedded object to include a video preview thumbnail. Another implementation may be configured to reveal a link preview after an inserted link has been tapped or clicked. In such an implementation, an inserted link may be displayed as text or a raw URL for example, wherein tapping or otherwise interacting with the inserted link does not activate the link but instead causes expansion of the display text or URL into a rich link preview. Consequently, a user can readily determine whether to activate the inserted link and take the additional time necessary to load all or some portion of a link target.

FIG. 4B depicts a link preview 400 as inserted with a link source. According to an embodiment, each link preview display can be configured with interactive controls (which can be hidden and surface upon user interaction), such as controls that enable a user to open the associated link, dock a link preview, edit a link preview, and/or delete a link preview. It will be appreciated that other architectures may include additional or fewer controls and control types. While one link preview 400 is shown by example, it will be appreciated that multiple link previews can be inserted into a link source.

As described above, a link tool interface can be configured to create, insert, modify, and/or persist rich link previews in a link source. A link can be inserted as text, a link preview, and/or attached to an existing object, but is not so limited. Users can use the link tool features to perform a number of actions including opening a link in its default application, copying a link preview into the clipboard, editing a link preview, and/or removing a link preview.

It will be appreciated that various features described herein can be implemented as part of a processor-driven environment including hardware and software components. Also, while certain embodiments and examples are described above for illustrative purposes, other embodiments are included and available, and the described embodiments should not be used to limit the claims. Suitable programming means include any means for directing a computer system or device to execute steps of a process or method, including for example, systems comprised of processing units and arithmetic-logic circuits coupled to computer memory, which systems have the capability of storing in computer memory, which computer memory includes electronic circuits configured to store data and program instructions or code.

An exemplary article of manufacture includes a computer program product useable with any suitable processing system. While a certain number and types of components are described above, it will be appreciated that other numbers and/or types and/or configurations can be included according to various embodiments. Accordingly, component functionality can be further divided and/or combined with other component functionalities according to desired implementations. The term computer readable media as used herein can include computer storage media or computer storage. The computer storage of an embodiment stores program code or instructions that operate to perform some function. Computer storage media can include volatile and nonvolatile, removable and non-removable media implemented in any method or technology for storage of information, such as computer readable instructions, data structures, program modules, etc.

System memory, removable storage, and non-removable storage are all computer storage media examples (i.e., memory storage.). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computing device. Any such computer storage media may be part of a device or system. By way of example, and not limitation, communication media may include wired media such as a wired network or direct-wired connection, and wireless media such as acoustic, RF, infrared, and other wireless media.

The embodiments and examples described herein are not intended to be limiting and other embodiments are available. Moreover, the components described above can be implemented as part of networked, distributed, and/or other computer-implemented environment. The components can communicate via a wired, wireless, and/or a combination of communication networks. Network components and/or couplings between components of can include any of a type, number, and/or combination of networks and the corresponding network components which include, but are not limited to, wide area networks (WANs), local area networks (LANs), metropolitan area networks (MANs), proprietary networks, backend networks, cellular networks, etc.

Client computing devices/systems and servers can be any type and/or combination of processor-based devices or systems. Additionally, server functionality can include many components and include other servers. Components of the computing environments described in the singular tense may include multiple instances of such components. While certain embodiments include software implementations, they are not so limited and encompass hardware, or mixed hardware/software solutions.

Terms used in the description, such as component, module, system, device, cloud, network, and other terminology, generally describe a computer-related operational environment that includes hardware, software, firmware and/or other items. A component can use processes using a processor, executable, and/or other code. Exemplary components include an application, a server running on the application, and/or an electronic communication client coupled to a server for receiving communication items. Computer resources can include processor and memory resources such as: digital signal processors, microprocessors, multi-core processors, etc. and memory components such as magnetic, optical, and/or other storage devices, smart memory, flash memory, etc. Communication components can be used to communicate computer-readable information as part of transmitting, receiving, and/or rendering electronic communication items using a communication network or networks, such as the Internet for example. Other embodiments and configurations are included.

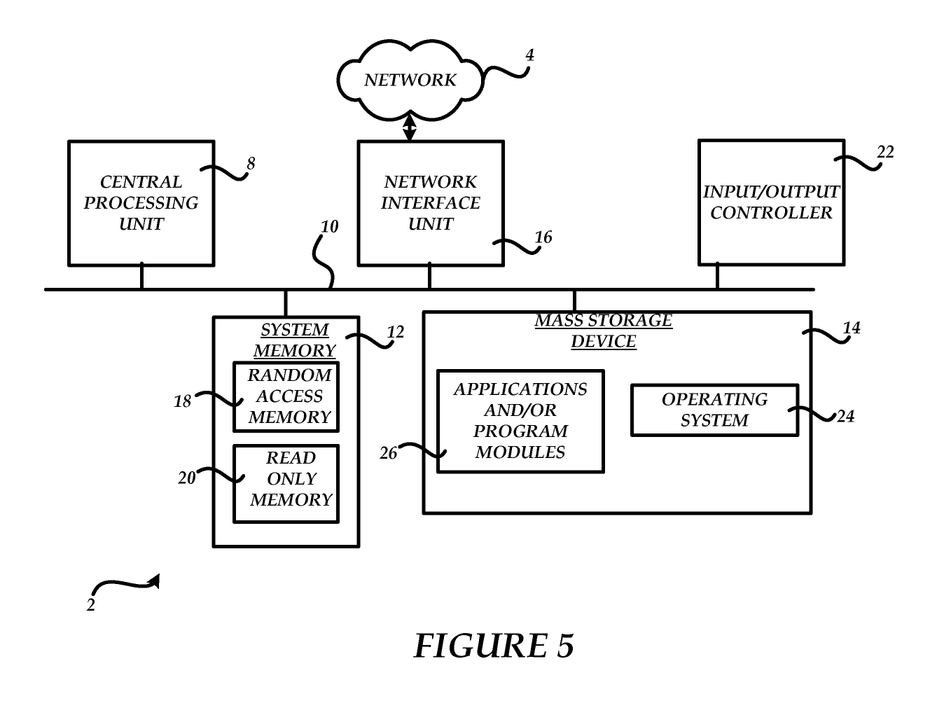

Referring now to FIG. 5, the following provides a brief, general description of a suitable computing environment in which embodiments be implemented. While described in the general context of program modules that execute in conjunction with program modules that run on an operating system on various types of computing devices/systems, those skilled in the art will recognize that the invention may also be implemented in combination with other types of computer devices/systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

As shown in FIG. 5, computer 2 comprises a general purpose server, desktop, laptop, handheld, or other type of computer capable of executing one or more application programs including an email application or other application that includes email functionality. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 24, application programs, and other program modules/resources 26.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

According to various embodiments, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 24 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as word processing, spreadsheet, drawing, e-mail, and other applications and/or program modules, etc.

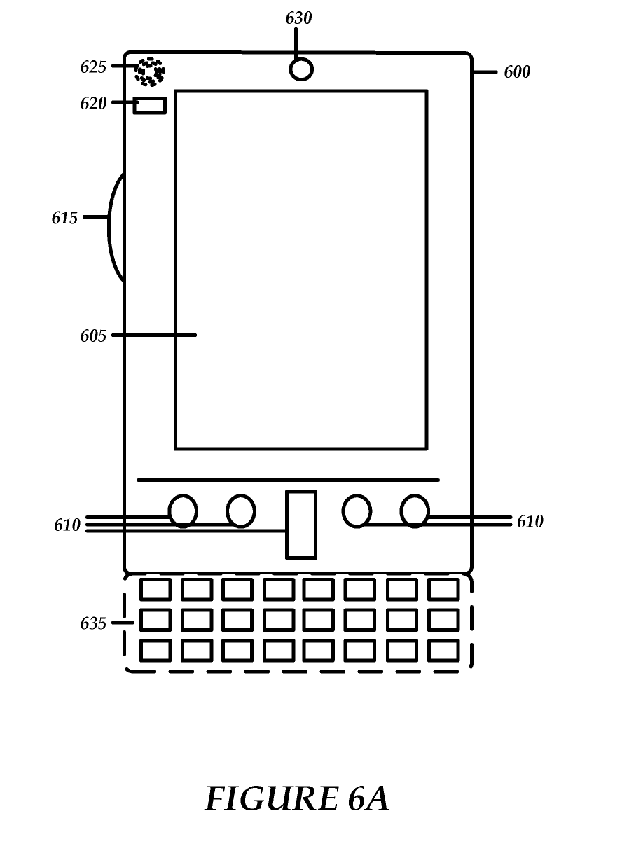

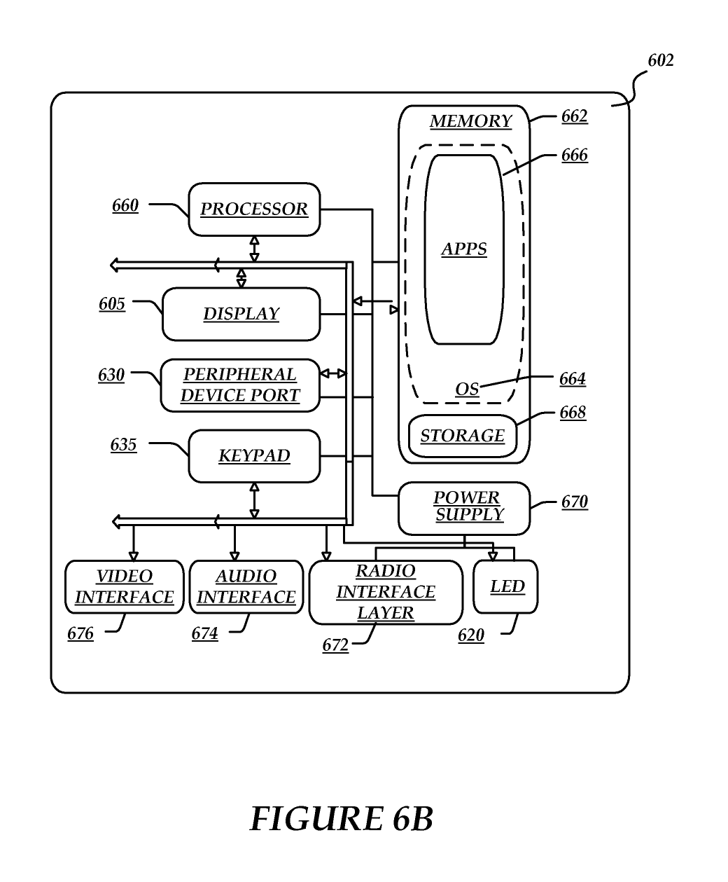

FIGS. 6A-6B illustrate a mobile computing device 600, for example, a mobile telephone, a smart phone, a tablet personal computer, a laptop computer, and the like, with which embodiments may be practiced. With reference to FIG. 6A, one embodiment of a mobile computing device 600 for implementing the embodiments is illustrated. In a basic configuration, the mobile computing device 600 is a handheld computer having both input elements and output elements.

The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative embodiments, mobile computing device 600 may incorporate more or less input elements. For example, the display 605 may not be a touch screen in some embodiments. In yet another alternative embodiment, the mobile computing device 600 is a portable phone system, such as a cellular phone.

The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some embodiments, the mobile computing device 600 incorporates a vibration transducer for providing the user with tactile feedback. In yet another embodiment, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one embodiment of a mobile computing device. That is, the mobile computing device 600 can incorporate a system (i.e., an architecture) 602 to implement some embodiments. In one embodiment, the system 602 is implemented as a “smart phone” capable of running one or more applications (e.g., browser, e-mail, calendaring, contact managers, messaging clients, games, and media clients/players). In some embodiments, the system 602 is integrated as a computing device, such as an integrated personal digital assistant (PDA) and wireless phone.

One or more application programs 666, including a notes application, may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down.

The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

The system 602 has a power supply 670, which may be implemented as one or more batteries. The power supply 670 might further include an external power source, such as an AC adapter or a powered docking cradle that supplements or recharges the batteries. The system 602 may also include a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 666 via the operating system 664, and vice versa.

The visual indicator 620 may be used to provide visual notifications and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device.

The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments, the microphone may also serve as an audio sensor to facilitate control of notifications, as will be described below. The system 602 may further include a video interface 676 that enables an operation of an on-board camera 630 to record still images, video stream, and the like. A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

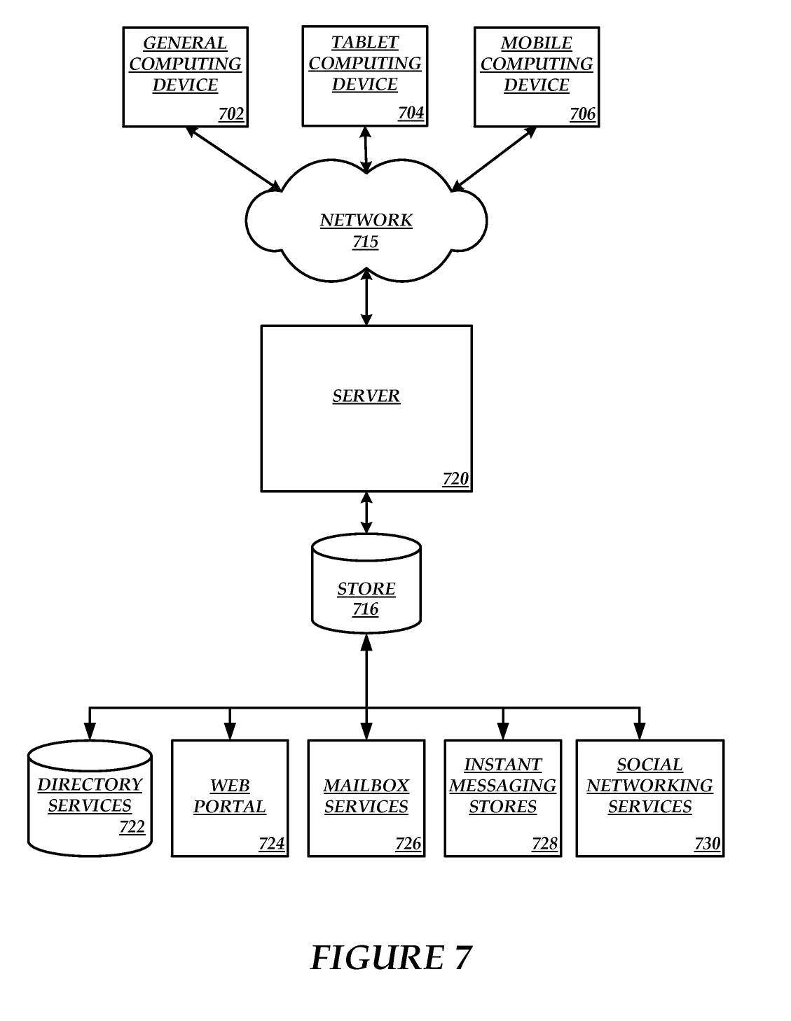

FIG. 7 illustrates one embodiment of a system architecture for implementing link interface features. Link processing information may be stored in different communication channels or storage types. For example, various information may be stored/accessed using a directory service 722, a web portal 724, a mailbox service 726, an instant messaging store 728, and/or a social networking site 730. A server 720 may provide additional link management and other features. As one example, the server 720 may provide rules that are used to distribute outbound email using a number of datacenter partitions over network 715, such as the Internet or other network(s) for example. By way of example, the client computing device may be implemented as a general computing device 702 and embodied in a personal computer, a tablet computing device 704, and/or a mobile computing device 706 (e.g., a smart phone). Any of these clients may use content from the store 716.

Embodiments, for example, are described above with reference to block diagrams and/or operational illustrations of methods, systems, computer program products, etc. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

It should be appreciated that various embodiments can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. An apparatus comprising:
processing and memory resources;
a link tool interface configured in part to display a link preview associated with a link target for insertion into a link source, wherein each link preview can operate to launch an associated link and includes a title display area, a link address display area, a description display area, and a thumbnail display area; and
a link preview manager configured in part to manage link preview information for populating one or more link previews.

2. The apparatus of claim 1, wherein each link preview is associated with a link target including an electronic word processing document or portion thereof, an email message or portion thereof, an electronic note or portion thereof, an electronic spreadsheet or portion thereof, an electronic presentation or portion thereof, a web page or portion thereof, a video or portion thereof, or an electronic calendar or portion thereof.

3. The apparatus of claim 1, wherein the link tool interface is configured to switch between a display text view and a link preview view.

4. The apparatus of claim 1, wherein the link tool interface is configured to display one or more potentially relevant link previews for persisting with a link source.

5. The apparatus of claim 1, wherein the link tool interface is configured to display a plurality of link suggestions for most recently used items.

6. The apparatus of claim 1, wherein the link tool interface is configured to display a link preview and allow modifications to one or more link preview portions.

7. The apparatus of claim 1, wherein the link tool interface is configured to automatically populate link preview items.

8. An article of manufacture configured with instructions that operate to provide link features by:
providing an insert link tool configured to receive input associated with a link address of a link;
using the insert link tool as part of displaying a modifiable link preview associated with the link, wherein the link preview includes a title, a link address, a description, and a thumbnail; and
using the insert link tool to insert the link preview as part of a link source.

9. The article of manufacture of claim 8, wherein the instructions operate further to provide the link features by automatically populating an address portion of the insert link tool with a link address of an identified item relevant to the user or context.

10. The article of manufacture of claim 8, wherein with instructions operate further to provide the link features by deep linking to portions of a link target.

11. The article of manufacture of claim 8, wherein the instructions operate further to provide link features by enabling modification of portions of the link preview.

12. The article of manufacture of claim 11, wherein the instructions operate further to provide link features by enabling modification of a suggested link preview before inserting a suggested link into the link source.

13. The article of manufacture of claim 8, wherein the instructions operate further to provide link features by storing the link preview for use and reuse.

14. The article of manufacture of claim 8, wherein the instructions operate further to provide link features by providing an option of not including a thumbnail portion of the link preview.

15. A method comprising:
using a link tool as part of inserting a link preview into a link source; and
displaying the link preview with the link source, wherein the link preview includes a title portion, a link address portion, a description portion, and a thumbnail portion.

16. The method of claim 15, further comprising automatically populating an address portion of the link tool.

17. The method of claim 16, further comprising automatically populating an address portion of the link tool with a link address of a designated MRU item.

18. The method of claim 15, further comprising inserting the link preview as part of the link source.

19. The method of claim 18, further comprising persisting the link preview with the link source.

20. The method of claim 15, further comprising displaying a plurality of potentially relevant items as link preview suggestions.
